(19) United States
(12) Patent Application Publication
(10) Pub. No.: US 2018/0037103 A1
(43) Pub. Date: Feb. 8, 2018

(54) ROCKET MOTOR INTEGRATION

(71) Applicant: Advanced Reaction Motor Systems Limited, Derby (GB)

(72) Inventor: Roger Mark SLOMAN, Derbyshire (GB)

(21) Appl. No.: 15/531,292

(22) PCT Filed: Nov. 27, 2015
(86) PCT No.: PCT/GB2015/053627

§ 371 Date: May 26, 2017

(30) Foreign Application Priority Data
Nov. 28, 2014 (GB) 1421208.8

(51) Int. Cl. B60K 5/08; F41H 7/04

(52) U.S. Cl. CPC B60K 5/08; F41H 7/044; B60K 2005/003

(57) ABSTRACT

A vehicle is provided which includes a vehicle support structure having a casing of a rocket motor that is arranged to sustain an inertial load generated, at least in part, by the vehicle when the rocket motor is inactive. In some examples, the vehicle is a land-based vehicle and the vehicle support structure includes a roll cage. In other examples, the vehicle is a helicopter and the vehicle support structure is a skid structure.

### TECHNOLOGICAL FIELD

Embodiments of the present invention relate to the integration of a rocket motor into a vehicle. In particular, they relate to the integration of a rocket motor into a support structure of a land-based vehicle or a helicopter.

### BACKGROUND

A rocket motor/engine comprises propellant which, when ignited, causes the rocket motor to eject gas. Ejection of the gas generates thrust.

### BRIEF SUMMARY

According to some, but not necessarily all, embodiments of the invention there is provided a vehicle, comprising: a vehicle support structure comprising a casing of a rocket motor that is arranged to sustain an inertial load generated, at least in part, by the vehicle when the rocket motor is inactive; wherein the casing has a length dimension, a width dimension and a depth dimension, the length dimension being greater than the width dimension and the depth dimension; and wherein the rocket motor is configured to generate a force in a direction that is substantially perpendicular to the length dimension of the casing.

According to some, but not necessarily all, embodiments of the invention there is provided a land-based vehicle, comprising: a roll cage comprising a rocket motor that is arranged to sustain an inertial load generated, at least in part, by the vehicle.

According to some, but not necessarily all, embodiments of the invention there is provided a land-based vehicle, comprising: a vehicle support structure comprising a casing of a rocket motor that is arranged to sustain an inertial load generated during motion of the vehicle, while the rocket motor is inactive.

According to some, but not necessarily all, embodiments of the invention there is provided a helicopter, comprising: a skid structure comprising a rocket motor that is arranged to sustain an inertial load generated, at least in part, by the mass of the helicopter.

According to some, but not necessarily all, embodiments of the invention there is provided a pallet comprising: at least one rocket motor having a casing; wherein the casing has a length dimension, a width dimension and a depth dimension, the length dimension being greater than the width dimension and the depth dimension; and wherein the rocket motor is configured to generate a force in a direction that is substantially perpendicular to the length dimension of the casing.

### BRIEF DESCRIPTION

For a better understanding of various examples of the embodiments of the present invention, reference will now be made by way of example only to the accompanying drawings in which:

FIG. 1 illustrates a perspective view of the first example of a linear rocket motor;

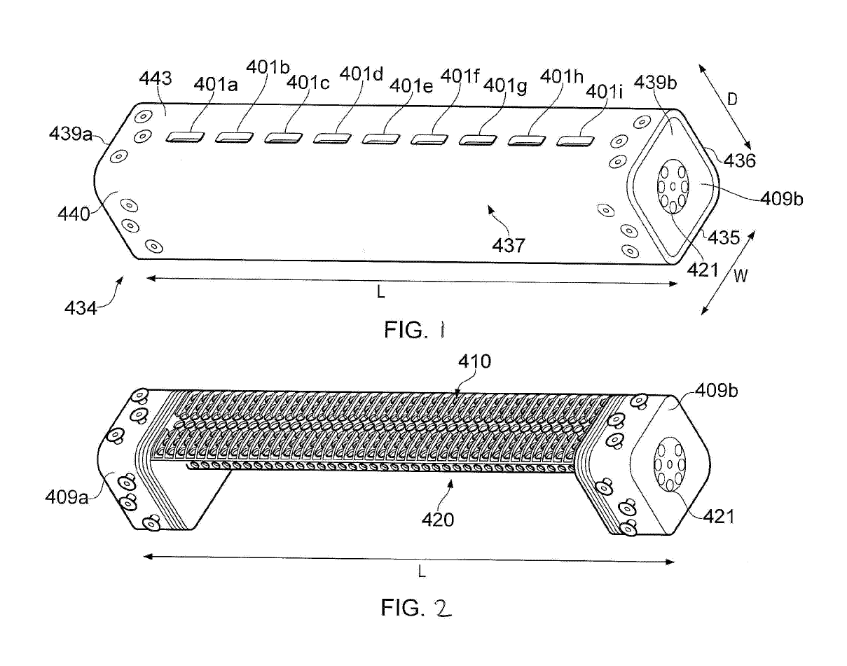

FIG. 2 illustrates a perspective view of some component parts of the first example of a linear rocket motor;

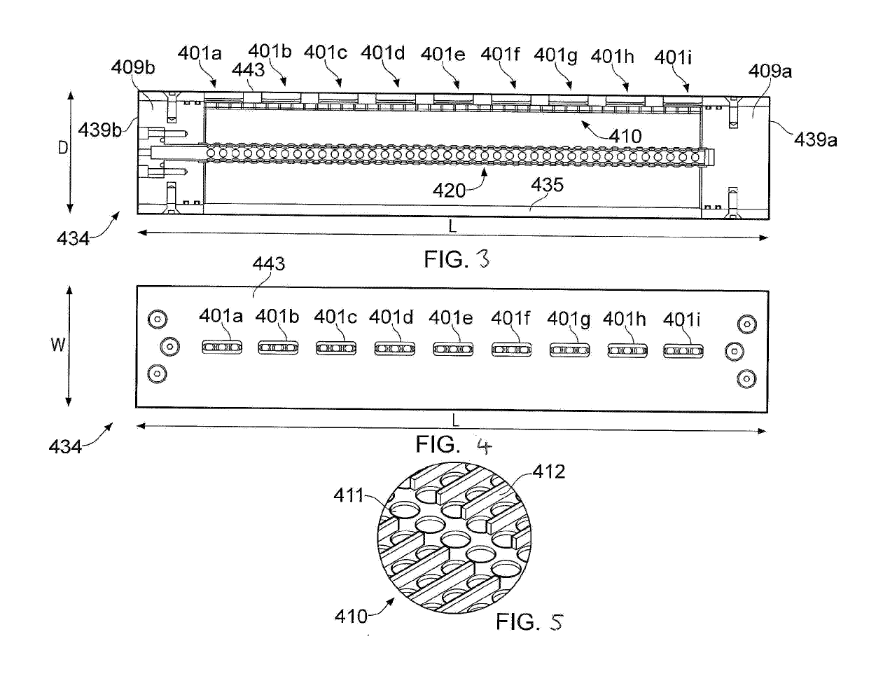

FIG. 3 illustrates a cross-sectional view of the first example of a linear rocket motor;

FIG. 4 illustrates a plan view of the first example of a linear rocket motor;

FIG. 5 illustrates a filter from the first example of a linear rocket motor;

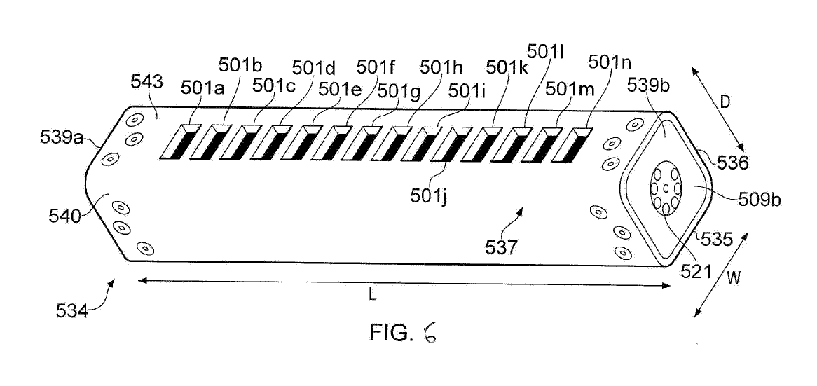

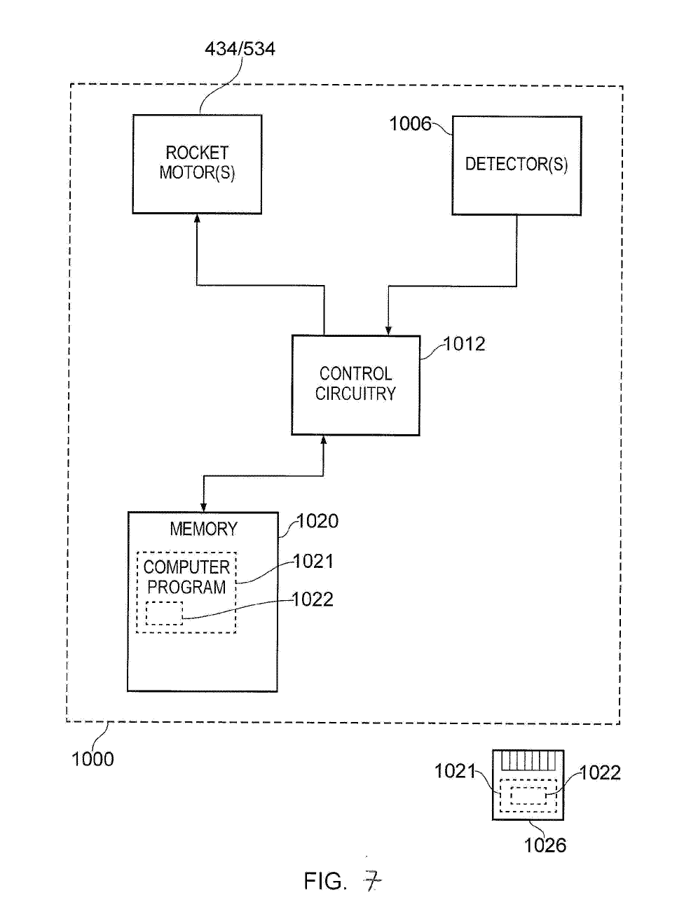

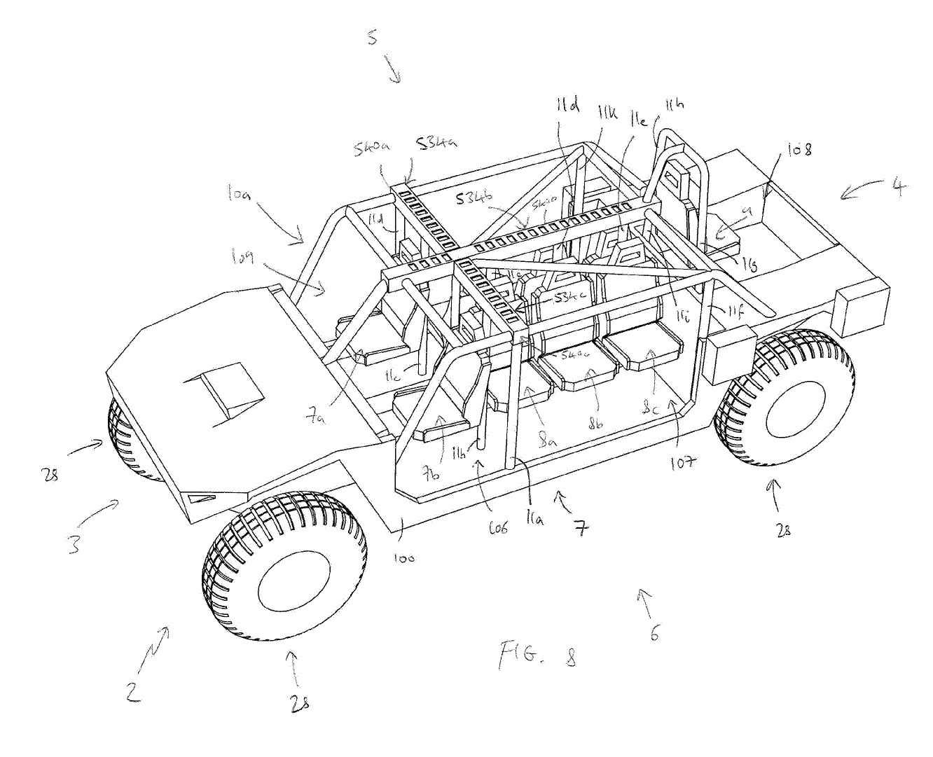

FIG. 6 illustrates a perspective view of a second example of a linear rocket motor;

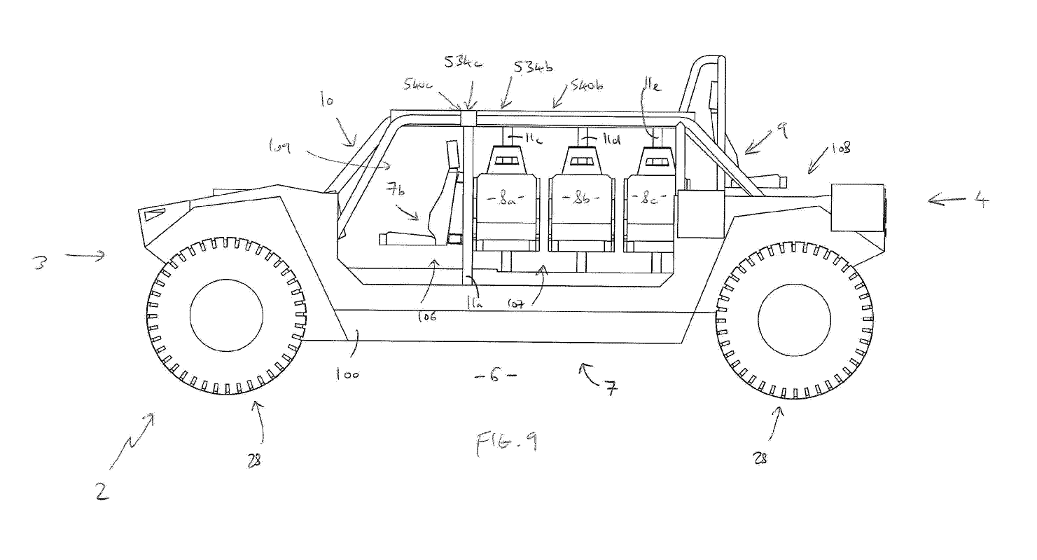

FIG. 7 illustrates a schematic of an apparatus;

FIG. 8 illustrates a perspective view of a land-based vehicle;

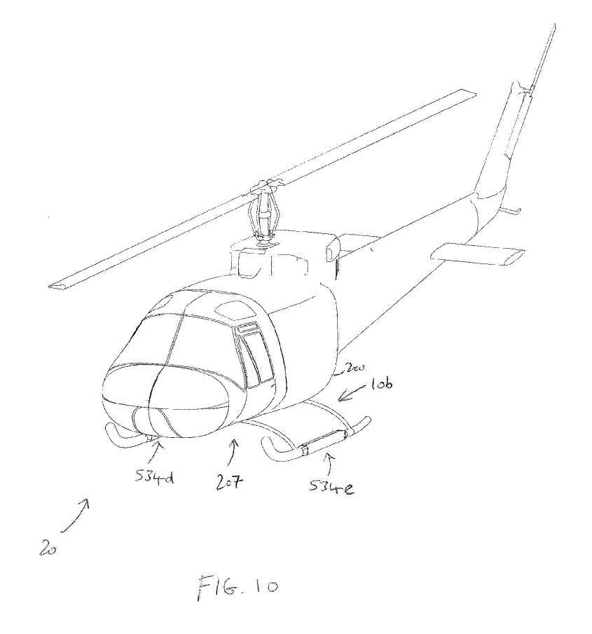

FIG. 9 illustrates a side view of the land-based vehicle;

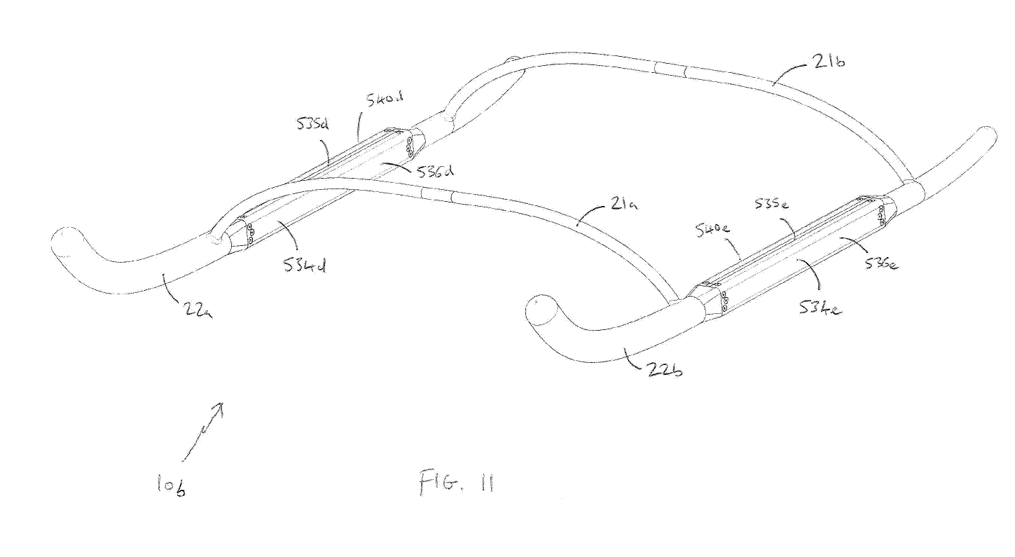

FIG. 10 illustrates an aircraft in the form of a helicopter;

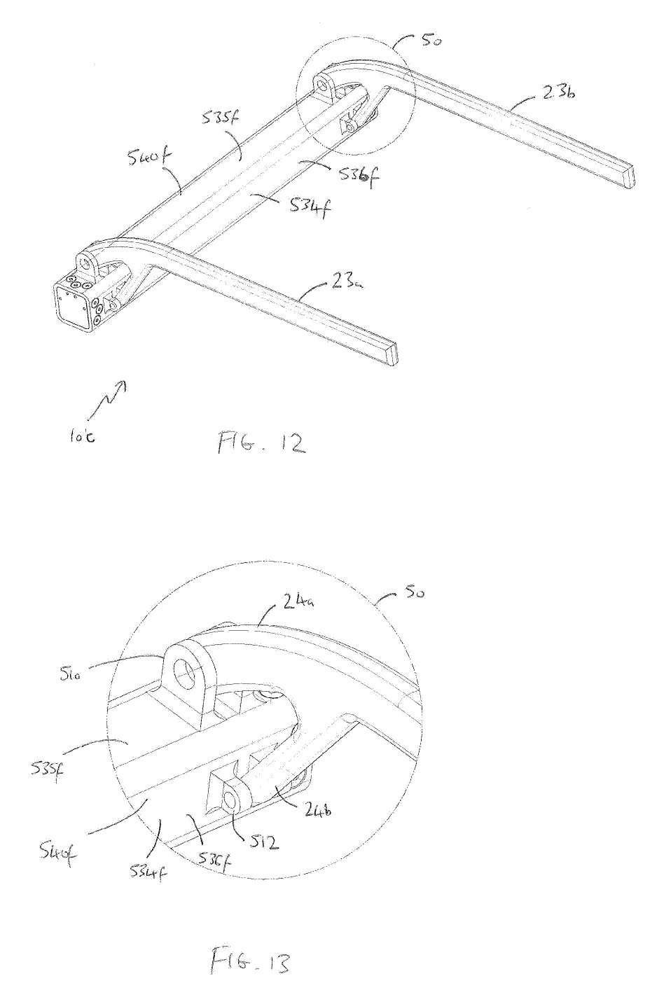

FIG. 11 illustrates a first example of a support structure for the helicopter;

FIG. 12 illustrates a portion of a second example of the support structure for the helicopter;

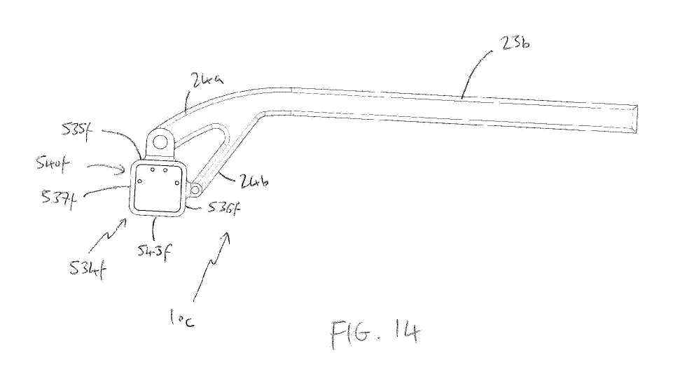

FIG. 13 illustrates an expanded view of a connection between a cross bar and a linear rocket motor in the second example of the support structure for the helicopter;

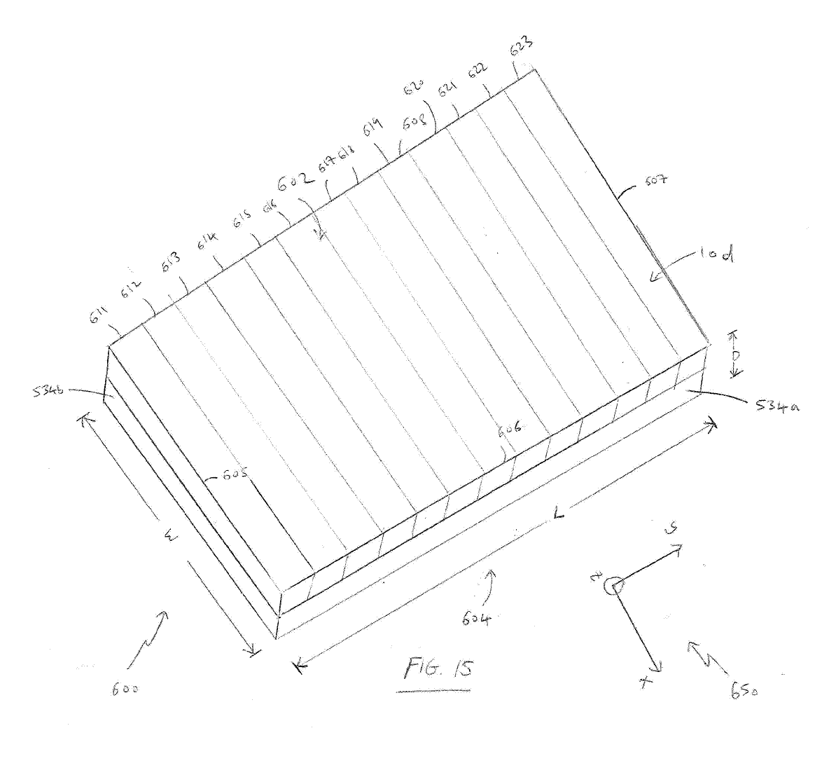

FIG. 14 illustrates a cross-sectional view of a portion of the second example of the support structure for the helicopter;

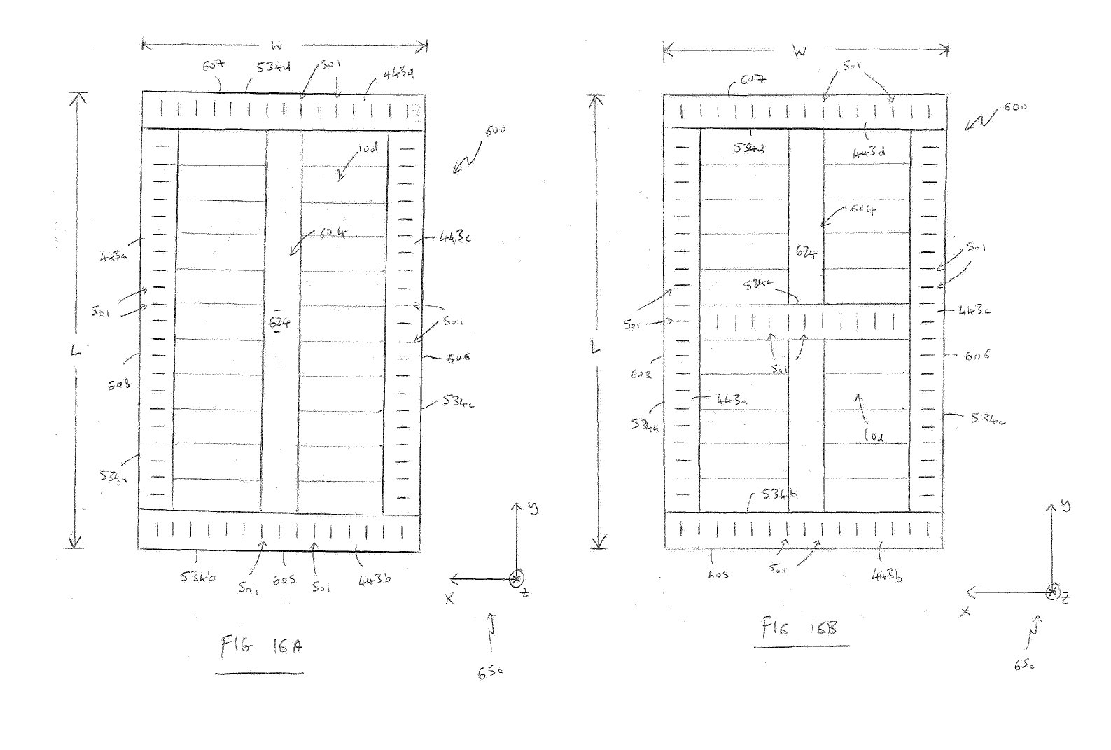

FIG. 15 illustrates a perspective view of a pallet for transporting goods;

FIG. 16A illustrates a plan view of an underside of a first example of the pallet; and

FIG. 16B illustrates a plan view of an underside of a second example of the pallet.

### DETAILED DESCRIPTION

Embodiments of the invention relate to integrating a rocket motor into a vehicle. The rocket motor is integrated into a support structure of the vehicle which comprises a casing of the rocket motor. The casing is arranged to sustain an inertial load generated, at least in part, by the vehicle when the rocket motor is inactive. The inertial load may be generated, for example, by motion of the vehicle. Alternatively or additionally, the inertial load may be/include a gravitational load which is generated, at least in part, by the vehicle.

The vehicle is for transporting people or goods. It may or may not be self-propelled. In some examples, the vehicle is configured to transport multiple people, one of whom may be the driver of the vehicle, and possibly goods in addition. In other examples, the vehicle is configured to transport only a single person, possibly alongside goods, and that person might be the driver of the vehicle. In some further examples, the vehicle may be configured to transport goods and not people.

In some examples, the vehicle is a land-based vehicle. In other examples, the vehicle is an aircraft such as a helicopter. In further examples, the vehicle is a spacecraft. An example of a vehicle for transporting goods and not people is a pallet.

FIG. 1 illustrates a perspective view of a first example 434 of a rocket motor.

The rocket motor includes a casing 440 having a length dimension L, a width dimension W and a depth dimension D. The length dimension L, the width dimension W and the depth dimension D are substantially orthogonal to one another. The first example 434 of the rocket motor may be elongate in shape such that the length dimension L is much greater than the width dimension W and the depth dimension D. For this reason, the rocket motor may be hereinafter referred to as a “linear rocket motor”.

In some examples, the length dimension L may be at least 1.25 times as great the width dimension W and/or at least 1.25 times as great as the depth dimension D. In other examples, the length dimension L may be at least twice as great as the width dimension W and/or at least twice as great as the depth dimension D. In some further examples, the length dimension L may be at least five times as great as the width dimension W and/or at least five times as great as the depth dimension D. In some implementations, the length dimension L is in the region of 125 millimetres to 100 metres, the width dimension W is in the region of 100 to 300 millimetres and the depth dimension D is in the region of 100 to 500 millimetres.

The casing 440 in the first example 434 comprises a base 435, a front wall 439a, two side walls 436, 437, a rear wall 439b and an upper wall 443. The casing 440 might be made from aluminium or one or more other metals. The two side walls 436, 437 are substantially planar in the illustrated example. The side walls 436, 437 are substantially parallel to one another, substantially orthogonal to the front and rear walls 439a, 439b and substantially orthogonal to both the base 435 and the upper wall 443.

The base 435 and the upper wall 443 are substantially planar in the illustrated example. The base 435 and the upper wall 443 are substantially parallel to one another, substantially orthogonal to the front and rear walls 439a, 439b and substantially orthogonal to each of the side walls 436, 437.

The front wall 439a and the rear wall 439b are substantially planar in the illustrated example. The front wall 439a and the rear wall 439b are substantially parallel to one another, substantially orthogonal to the side walls 436, 437 and substantially orthogonal to the base 435 and the upper wall 443.

The base 435, the side walls 436, 437, the front wall 439a and the rear wall 439b define a chamber in which (solid) propellant may be stored. In some examples, the propellant may be a single item. It may have a honeycomb structure. Alternatively, the propellant may take the form of one or more fins and/or one or multiple pellets. The pellets may or may not have perforations. The pellets may have a honeycomb structure.

The upper wall 443 comprises a plurality of efflux/gas exit apertures 401a, 401b, 401c, 401d, 401e, 401f, 401g, 401h, 401i. In this example, the length of each of the exit apertures 401a-401i is aligned with the length dimension L of the rocket motor 434. Some or all of the exit apertures 401a-401i may diverge in the direction of movement of the efflux/gas ejected from the casing 440 in operation.

In the illustrated example, the upper wall 443, the side walls 436, 437 and the base 435 are integrally formed, for example, using an extrusion process. Each of the front wall 439a and the rear wall 439b is partially formed from an edge of each of the upper wall 443, the side walls 436, 437 and the base 435 and also by a surface of an end cap 409a, 409b. The end cap 409b which forms part of the rear wall 439b can be seen in FIG. 1.

The end cap 409b includes an ignition connection 421 for an igniter 420 of the linear rocket motor 434. The igniter 420 is arranged to ignite propellant located inside the casing 440 of the linear rocket motor 434, which causes an efflux/gas to be ejected from the casing 440 via the exit apertures 401a-401i and which, in turn, causes a force to be generated that is substantially perpendicular to the length dimension L of the casing 440 (and substantially aligned with the depth dimension D).

FIG. 2 illustrates some component parts of the first example 434 of a linear rocket motor. FIG. 3 illustrates a cross section of the first example 434 of a linear rocket motor. FIG. 4 illustrates a plan view of the first example 434 of a linear rocket motor.

In order to show the component parts in FIG. 2, the side walls 436, 437, the base 435 and the upper wall 443 have been removed. It can be seen in FIGS. 2 and 3 that the igniter 420 extends across the length dimension L of the linear rocket motor 434 from one end cap 409a to the other end cap 409b.

In the illustrated example, a (substantially planar) filter 410 is present which is positioned above the igniter 420. Solid propellant (for example in pellet form, as described above may be positioned around the igniter 420.

The filter 410 is positioned between the propellant (not shown) and the gas exit apertures 401a-401i to prevent unburnt propellant (for instance, unburnt pellet pieces) from being ejected through the exit apertures 401a-401i in operation.

FIG. 5 illustrates a portion of the filter 410 in more detail. The filter 410 comprises a plurality of apertures 411 which enable gas to pass through the filter 410 but prevent chunks of unburnt propellant from passing through. The filter 410 also comprises a plurality of protrusions 412 which abut the inner surface of the upper wall 443.

FIG. 6 illustrates a perspective view of a second example 534 of a linear rocket motor. The second example 534 is the same as the first example 434 save for the orientation of the exit apertures 501a, 501b, 501c, 501d, 501e, 501f, 501g, 501h, 501i, 501j, 501k, 5011, 501m, 501n. In the second example 534, the length of the exit apertures is orthogonal to the length dimension L of the casing 540, rather than parallel to it.

The reference numerals 509b, 521, 535, 536, 537, 539a, 539b and 543 in FIG. 6 designate an end cap 509b, an ignition connection 521, a base 535, a first side wall 536, a second side wall 537, a front wall 539a, a rear wall 539b and an upper wall 543 respectively.

FIG. 7 illustrates a vehicle protection apparatus 1000. The apparatus 1000 may, for example, be for mitigating/preventing damage from being caused to a land-based vehicle, by applying a groundwards force to the vehicle in response to an explosion. Alternatively, the vehicle protection apparatus 1000 may be for mitigating/preventing damage from being caused to a descending aircraft, spacecraft or pallet, by applying an upwards force to the aircraft, spacecraft or pallet.

An explosive event local to a land-based vehicle can cause significant trauma to a vehicle and/or a vehicle's occupants. In order to protect the occupants of the vehicle from shrapnel and blast emanating from an explosive such as a bomb, mine or improvised explosive device (IED), some vehicles comprise armour.

The armour may protect the occupants of the vehicle against injury caused directly from the shrapnel and blast effects. However, depending upon the size of the explosive, some aspects of the vehicle (such as the floor of the vehicle if the explosion occurs underneath the vehicle) can be very heavily damaged. Furthermore, an explosion underneath or to the side of a vehicle may cause the vehicle to accelerate rapidly into the air, resulting in injury to the occupants either when being accelerated upwards or when the vehicle lands on the ground.

The detonation of a mine generates an initial shockwave which is very quickly followed by a blast wave. If the detonation occurs underneath the vehicle, these events cause damage to the vehicle and contribute to the vehicle being accelerated upwards into the air.

Immediately after the explosion occurs, there is an input of energy from the initial shockwave, the following reflected pressure waves, ejecta, and from localised very high pressure gas. Over the next few milliseconds, the gases produced by decomposition of the explosive from the mine expand underneath the vehicle and together with other contributors (to the total impulse imparted to the vehicle) may apply a large enough force to cause the vehicle to accelerate upwards into the air and fall onto its side or top. The effect of the expanding gases can be likened to a large airbag expanding very rapidly under the vehicle.

If the mine is buried very shallowly on very hard ground, the upwards force that is generated by the expanding gases is at maximum for around 5 milliseconds or so, and then rapidly reduces in value over the next 5 milliseconds to near zero. However, if the ground is softer and the mine is more deeply buried, the total time over which a particularly significant upwards force is exerted on the vehicle might generally be around 20-30 milliseconds.

Furthermore, in the case of a very deeply buried mine, gas escaping from the ground and the ejecta carried with it may continue to provide an impulse to the vehicle for another 30-500 milliseconds or so, depending on the depth of the burial of the explosive and the soil type and condition. The proportion of the total impulse imparted to the vehicle by the ejecta is very variable. If the mine is buried very deeply in a culvert under a road, practically all of the impulse may arise from the ejecta. If the mine is located on the top of a hard surface there may be very little or no contribution from the ejecta, and practically all of the lifting impulse will be generated by the gas pressure.

When the vehicle protection apparatus 1000 forms part of a land-based vehicle, it mitigates/prevents the damage caused to a vehicle by an explosion by counteracting the forces generated by the explosion and stabilizing the vehicle in response to the explosion. It may, advantageously, enable injury to the vehicle's occupants to be prevented or limited and enable the vehicle to remain upright and in fighting condition. This is explained in further detail below.

The vehicle protection apparatus 1000 illustrated in FIG. 7 may be applied to a vehicle during manufacture or post manufacture. The apparatus 1000 may, for example, be a kit of parts. The vehicle may be a land-based armoured vehicle. For example, the vehicle may be a civilian car, a modified sports utility vehicle, a lightweight Special Forces vehicle or a larger military armoured vehicle such as a personnel carrier or a tank.

The apparatus 1000 comprises one or more linear rocket motors 434/534, such as those described above in relation to FIGS. 1 to 6, one or more detectors 1006, control circuitry 1012 and memory 1020.

The control circuitry 1012 may, for example, be or comprise a single processor or multiple processors.

The control circuitry 1012 is configured to receive inputs from the one or more detectors 1006. The control circuitry 1012 is configured to provide outputs to the one or more rocket motors 434, 534. The control circuitry 1012 is also configured to write to and read from memory 120.

It will be appreciated by those skilled in the art that FIG. 7 is a functional schematic. In this regard, it should be recognised that intervening elements (such as additional circuitry) may be positioned between the control circuitry 1012 and each of the one or more rocket motors 434, 534, the one or more detectors 1006 and the memory 1020.

The memory 120 is illustrated in FIG. 7 as storing a computer program 1021 comprising computer program instructions 1022. The computer program instructions 1022 control the operating of the apparatus 1000 when loaded into the control circuitry 1012.

The computer program 1021 may arrive at the apparatus 1000 via any suitable delivery mechanism 1026. The delivery mechanism 1026 may be, for example, a (non-transitory) computer-readable storage medium, a computer program product, a memory device for a record medium such as a CD-ROM or DVD. The delivery mechanism may be a signal configured to provide the transfer the computer program instructions 1022.

In an alternative implementation, the control circuitry 1012 and/or the memory 1020 may be provided by a dedicated application specific integrated circuit (ASIC). In such an implementation, it may be that no computer program is required.

When the apparatus 1000 is for a land-based vehicle, the detectors 1006 are detectors for detecting that an explosion has occurred local to (for example, underneath) a vehicle. The detectors 1006 may be any type of detectors and may, for example, include: one or more pressure detectors, one or more temperature detectors and/or one or more light detectors.

The pressure detectors may, for example, be piezoelectric pressure detectors. Advantageously, piezoelectric pressure detectors operate effectively in adverse weather and ground conditions.

Alternatively or additionally, the detectors 1006 may include one or more break wire detectors. An explosion may cause a circuit of such a break wire detector to break, causing the break wire detector to provide an input to the processor 12.

Alternatively or additionally, the detectors 1006 may include one or more ionisation detectors for detecting ionised particles that result from an explosion.

Alternatively or additionally, the detectors 1006 may comprise one or more electromagnetic pulse detectors for detecting an electromagnetic pulse resulting from an explosion.

Alternatively or additionally, the detectors 1006 may comprise one or more accelerometers and/or one or more gyroscopes.

In operation, when an explosion occurs local to a land-based vehicle (such as underneath the vehicle), the explosion causes a blast shockwave. The detectors 1006 detect that an explosion has occurred local to the vehicle and provide inputs to the control circuitry 1012 which are indicative that an explosion has occurred. The control circuitry 1012 analyses the inputs provided by the detectors 1006 and determines than an explosion has occurred. The control circuitry 1012 then responds to the inputs provided by the detectors 1006 by causing the linear rocket motors 434, 534 to apply a groundwards force to the vehicle. The application of the groundwards force to the vehicle urges the vehicle towards ground and mitigates the upward forces generated by the blast shockwave from the explosion. Advantageously, this may enable the vehicle to remain upright and in fighting condition.

As explained above, the vehicle protection apparatus 1000 may also be for vehicles which are not land-based such as aircraft. The aircraft may, for example, be a helicopter. The aircraft may be operated by at least one pilot. The aircraft may be manned in that there is at least one pilot present in the aircraft. Alternatively, the aircraft may be unmanned and the pilot may be located remotely from the aircraft.

If the vehicle protection apparatus 1000 is for an aircraft, the one or more rocket motors 434, 534, control circuitry 1012 and the memory 1020 may be similar to those described above in the context of the application of the apparatus 1000 to a land-based vehicle. The detectors 1006 may, however, be different. For example, the detectors 1006 may be for detecting the proximity of the aircraft to terrain or water. The detectors 1006 may, for example, comprise one or more altimeters, and/or one or more radar arrangements. The detectors 1006 may also comprise one or more engine failure detectors and/or one or more fuel gauges.

In operation, the one or more detectors 1006 may detect that an aircraft has entered a state in which an upwards force is required, or likely to be required in due course. For example, this could be because an altimeter or a radar arrangement has detected that the aircraft is flying too close to terrain or water. It may be because the rate of descent is above a threshold value and the altitude of the aircraft is below a threshold value. Alternatively, it could be because an engine of the aircraft, or an aspect of an engine of the aircraft, has failed. Alternatively, it could be because the aircraft has run out of fuel.

The inputs provided by the detectors 1006 are analysed by the control circuitry 1012 to determine when to cause an upwards force to be provided to the aircraft. This may be immediately, or after a period of time has elapsed.

At an appropriate point in time, the control circuitry 1012 causes the one or more rocket motors 434/534 to apply an upwards force to the aircraft. The upwards force is applied when the one or more rocket motors 434/534 eject gas towards ground.

The upwards force may, for example, be applied in response to detection of a potential collision by the detectors 1006. The potential collision could, for example, be potential controlled or uncontrolled flight into terrain.

The application of the upwards force reduces the rate of descent of the aircraft and may, depending upon the aircraft, alter the pitch of the aircraft. Alternatively, the application of the upwards force may prevent a collision, or reduce the severity of the collision.

FIG. 8 illustrates a perspective view of an example of a, self-propelled, land-based vehicle that comprises the apparatus 1000 illustrated in FIG. 7. In this example, the vehicle is a lightweight Special Forces vehicle. FIG. 9 illustrates a side view of the vehicle 2.

The vehicle 2 further comprises a body 100 and wheels 28. The illustrated vehicle 2 comprises four wheels 28, but in other implementations of the invention, the vehicle 2 may include a different quantity of wheels and/or may include tracks. The reference numerals 3, 4, 5, 6 and 7 in FIG. 8 designate the front, rear, first side, second side and underside of the vehicle 2 respectively.

The vehicle 2 has an occupant compartment 109 comprising three regions 106, 107 and 108 for housing occupants of the vehicle 2. The first region 106 comprises two front facing seats 7a, 7b, one of which may be for the driver of the vehicle 2. The second region 107 of the vehicle 2 is located behind the first region 106 and comprises six seats in the illustrated example, three of which face towards the first side 5 of the vehicle 2 and three of which face towards the second side 6 of the vehicle 2. The seats facing the second side 6 of the vehicle 2 are labelled with the reference numerals 8a, 8b and 8c in FIG. 8. The third region 108 is located behind the second region 107 and comprises a further seat 9 facing towards the rear 4 of the vehicle.

The vehicle 2 further comprises a vehicle support structure 10a in the form of a roll cage. The support structure 10a comprises a plurality of upwardly extending supports 11a, 11b, 11c, 11d, 11e, 11f, 11g, 11h and 11i. Each of the supports 11a-11i is substantially vertical in the illustrated example. The two front facing seats 7a, 7b are connected to first and second supports 7a, 7b. The three seats facing the first side 5 of the vehicle 2 are connected to third, fourth and fifth supports 11c, 11d, 11e. The three seats 8a-8c facing the second side 6 of the vehicle 2 are also connected to the third, fourth and fifth supports 11c, 11d, 11e. The seat 9 facing the rear 4 of the vehicle 2 is connected to sixth and seventh supports 11g, 11 h.

Each of the seats is connected to its support(s) using at least one spring. If and when the rocket motors 534a, 534b, 534c are activated, a groundwards force is applied to the vehicle 2. This force is applied through the supports 11a-11i, causing the supports 11a-11i and other aspects of the vehicle 2 to move groundwards. The springs which connect the seats to the supports 11a-11i enable the seats to remain in substantially the same position (or, at least, to move to a lesser extent than the supports 11a-11i), which keeps movement of any occupants in the vehicle 2 to a minimum and helps to reduce/prevent injury to those occupants.

Three rocket motors 534a, 534b, 534c, and their respective casings 540a, 540b, 540c, form part of the support structure 10a. The support structure 10a and the rocket motor casings 540a, 540b, 540c therein form a load bearing structural element of the vehicle 2, such that when the vehicle 2 is in motion and the rocket motors 534a, 534b, 534c are inactive, the structure 10a and the casings 540a, 540b, 540c therein bear an inertial load which enables the vehicle to function as a moving vehicle. The inertial load results from movement of the vehicle 2 and is therefore generated (at least in part) by the vehicle 2.

The expression “the rocket motors 534a, 534b, 534c are inactive” is intended to mean that the propellent inside the rocket motors 534a, 534b, 534c has not been ignited and the rocket motors 534a, 534b, 534c are not providing a groundwards force in response to detection of an explosion. The motion of the vehicle 2 is therefore being caused by a source that is different from the rocket motors 534a, 534b, 534c, such as an internal combustion engine of the vehicle 2.

In the illustrated example, if the support structure 10a were not present, the vehicle 2 would not be able to function as a moving vehicle because an essential load bearing part of the vehicle 2 would not be present.

In the example illustrated in FIG. 8, linear rocket motors 534a, 534b, 534c are located above the first and second regions 106, 107 and their casings are integrally formed into the vehicle support structure 10a. The linear rocket motors 534a, 534b, 534c have the same form as the linear rocket motor 534 illustrated in FIG. 6, but in other implementations some or all of them may alternatively have the structure of the linear rocket motor 434 illustrated in FIGS. 1 to 5.

When the rocket motors 534a, 534b, 534c are activated by the control circuitry 1012, an efflux which is directed away from ground is generated which causes a groundwards force to be applied to the vehicle 2.

FIG. 10 illustrates an aircraft 20 in the form of a self-propelled helicopter which comprises a body/fuselage 200, a vehicle support structure 10b and the apparatus 1000 illustrated in FIG. 7. The body/fuselage 200 defines an internal enclosure for housing occupants of the helicopter 20. The vehicle support structure 10b comprises rocket motors 534d and 534e. The structure 10 and the casings 540d, 540e of the rocket motors 534d, 534e therein are arranged to sustain an inertial load generated, at least in part, by the aircraft/helicopter 20 when the rocket motors 534d, 534e are inactive.

The inertial load may be generated, at least in part, by the fuselage 200 of the helicopter 20. In this example, the inertial load is generated, at least in part, by the mass of the helicopter 20. The inertial load may, for instance, be a gravitational load. A gravitational load is a type of inertial load that is generated by the mass of a body (such as the fuselage 200) and the Earth's gravitational pull. Other types of inertial loads are also generated by the mass of a body (such as the fuselage 200) but the source of acceleration is different from the Earth's gravitational pull.

The inertial load may, for instance, result from the helicopter 20 being positioned stationary on ground, from upwards movement of the helicopter 20 during take-off or from the helicopter 20 interacting with ground during landing.

The expression “the rocket motors 534d, 534e are inactive” is intended to mean that the propellant inside the rocket motors 534d, 534e has not been ignited and the rocket motors 534a, 534b, 534c are not providing an upwards force to prevent/mitigate excessively rapid descent of the helicopter 20.

FIG. 11 illustrates the support structure 10b in more detail. The support structure 10b comprises a first helicopter skid 22a and a second helicopter skid 22b. The first and second helicopter skids 22a, 22b are connected by the first and second crossbars 21a, 21b. Each of the first and second crossbars 21a, 21b are connected to an underside 207 of the body/fuselage 200 of the helicopter 20.

It can be seen from FIG. 11 that the casings 540d, 540e of the rocket motors 534d, 534e are integrally formed into the support structure 10b. In this example, the casings 540d, 540e of the rocket motors 534d, 534e are integrated into the first and second skids 22a, 22b in such a way that the bases 535d, 535e of the rocket motors 534d, 534e face upwardly.

Reference numeral 536d denotes an inwardly facing side wall of the rocket motor 534d integrated into the first skid 22a and the reference numeral 536e denotes an outwardly facing side wall of the rocket motor 534e that is integrated into the second skid 22b. The wall of each rocket motor 534d, 534e that comprises the exit apertures faces downwards. This means that when each rocket motor 534d, 534e is activated by the control circuitry 1012, a groundwards efflux is generated which causes an upwards force to be applied to the body of the aircraft 200.

The support structure 10b is a skid structure that, together with the casings 540d, 540e of the rocket motors 534d, 534e therein, is arranged to sustain an inertial load generated by the mass of the (body 200 of the) helicopter 20. The inertial load may, for instance, be a gravitational load generated by the mass of the helicopter 20.

FIGS. 12 to 14 illustrate an alternative example 10c of the vehicle support structure illustrated in FIGS. 10 and 11. In the vehicle support structure 10c illustrated in FIGS. 12 to 14, the first and second crossbars 23a, 23b each comprise first and second arms which attach to the casing 540f of a rocket motor 534f (and therefore to a skid of a helicopter).

As in the FIG. 11 example, the base 535f of the rocket motor 534f faces upwardly and the wall comprising the exit apertures faces downwardly. Reference numeral 536f in FIG. 12 denotes an inwardly facing side wall of the support structure 10c.

FIG. 13 illustrates a magnified view of the area labelled with the reference numeral 50 in FIG. 12. FIG. 14 illustrates a cross-sectional view of the second crossbar 23b and the rocket motor 534f illustrated in FIG. 12.

The first and second crossbars 23a, 23b have the same structure. It can be seen in FIG. 13 that the second crossbar 23b has a first arm 24a which connects to a first connection point 510 on the upwardly facing base 535f of the rocket motor 534f. A second arm 24b of the crossbar 23b connects to a second connection point 512 on an inwardly facing side wall 536f of the rocket motor 534f. In FIG. 14, the reference numerals 537f and 543f denote an outwardly facing side wall and a downwardly facing wall (comprising exit apertures) respectively.

FIG. 15 illustrates a perspective view of a vehicle for transporting goods (and not people) in the form of a pallet 600. The pallet 600 comprises the apparatus 1000 illustrated in FIG. 7.

Cartesian co-ordinate axes 650 comprising x, y and z axes are illustrated in FIG. 15. A length dimension L of the pallet 600 is aligned with the y-axis, a width dimension W of the pallet 600 is aligned with the x-axis, and a depth dimension D of the pallet 600 is aligned with the z-axis. The z-axis is directed out of the page in FIG. 15.

The pallet 600 comprises has a support structure 10d, which in the example illustrated in FIG. 15 includes a plurality of elongate members 611-623 extending in the width dimension W of the pallet 600 and at least one transverse elongate member 624 extending in the length L dimension. In the example illustrated in the figures, a transverse elongate member 624 is positioned beneath the plurality of elongate members 611-623 (see FIGS. 16A and 16B).

The pallet 600 illustrated in FIG. 15 has an upper surface 602 and an underside 604. The outer extremities of the pallet 600 are defined by the first, second, third and fourth edges 605-608 of the pallet 600. In the illustrated example, the upper surface 602 of the pallet 600 is generally rectangular in shape, but it may be different in other examples. For instance, it may be generally square in shape.

A plurality of linear rocket motors may be integrated into the support structure 10d of the pallet 600. FIG. 16A illustrates the underside 604 of a first example of a pallet 600 which includes first, second, third and fourth linear rocket motors 534a-534d. In this example, the linear rocket motors 534a-534d are those illustrated in FIG. 6, but in other examples they could have an alternative form, such as that illustrated in FIGS. 1 to 5.

The first and third linear rocket motors 534a, 534c extend along the length dimension L of the pallet 600 at the second and fourth edges 606, 608 of the pallet 600. The second and fourth linear rocket motors 534b, 534d extend along the width dimension W of the pallet 600 at the first and third edges 605, 607 of the pallet 600.

The linear rocket motors 534a-534d are arranged such that their bases 535 face upwardly and the wall 443a-443d of each linear rocket motor 534a-534d that comprises the exit apertures 501 faces downwards.

The pallet 600 may be for use in supplying military equipment, such as logistical equipment and/or munitions. The equipment may be positioned on the upper surface 602 of the pallet 600 and secured in place using one or more nets, for instance. In use, the pallet 600 may be dropped from an aircraft to ground in order to provide the equipment on the pallet 600 to ground forces.

The casings 540 of the linear rocket motors 534a-534d are integrally formed into the support structure 10d of the pallet 600. The support structure 10d, including the casings 540 of the linear rocket motors 534a-534d therein, is arranged to sustain an internal load generated by the mass of the pallet 600 (while the linear rocket motors 534a-534d are inactive). The internal load may, for example, be a gravitational load generated by the mass of the pallet 600 when it is dropped.

After the pallet 600 has been dropped, the control circuitry 1012 may activate the linear rocket motors 534a-534d, generating a downwards efflux and causing an upwards force to be applied to the pallet 600. This causes the rate of descent of the pallet 600 to slow before it reaches the ground, preventing goods that are being transported on the pallet 600 from being destroyed/damaged when the pallet 600 impacts the ground.

The example illustrated in FIG. 16B is the same as that illustrated in FIG. 16A, except that it includes a further linear rocket motor 534e positioned along a central portion of the pallet 600 and extending in the width dimension W. The addition of a further rocket motor 534e enables a greater upwards force to be generated and may improve the structural integrity of the pallet 600. In practice, a pallet 600 could include any number of linear rocket motors 534a-534e.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Where elements have been defined or described as being “connected” to one another, this should be interpreted to cover i) those elements may directly connected together (with no intervening elements) and ii) those elements being connected together via intervening elements.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

1. A vehicle, comprising:
a vehicle support structure comprising a casing of a rocket motor that is arranged to sustain an inertial load generated, at least in part, by the vehicle when the rocket motor is inactive;
wherein the casing has a length dimension, a width dimension and a depth dimension, the length dimension being greater than the width dimension and the depth dimension; and
wherein the rocket motor is configured to generate a force in a direction that is substantially perpendicular to the length dimension of the casing.

2. The vehicle as claimed in claim 1, wherein the casing of the rocket motor is integrally formed into the vehicle support structure.

3. The vehicle as claimed in claim 1 or 2, wherein the rocket motor is arranged to generate an efflux from the casing in a direction that is substantially perpendicular to the length dimension of the casing.

4. The vehicle as claimed in claim 3, wherein the vehicle is a land-based vehicle.

5. The vehicle as claimed in claim 4, wherein the rocket motor is arranged to generate a groundwards force by directing the efflux away from ground.

6. The vehicle as claimed in claim 4, wherein the rocket motor is arranged to sustain an inertial load generated by motion of the vehicle.

7. The vehicle as claimed in claim 4, wherein the rocket motor is located above an occupant compartment of the vehicle.

8. The vehicle as claimed in claim 4, wherein the rocket motor forms part of a roll cage of the vehicle.

9. The vehicle as claimed in claim 1, wherein the vehicle is a pallet.

10. The vehicle as claimed in any of claim 1, wherein the vehicle is an aircraft.

11. The vehicle as claimed in claim 10, wherein the rocket motor is arranged to generate an upwards force by directing the efflux towards ground.

12. The vehicle as claimed in claim 10, wherein the rocket motor is configured to reduce a rate of descent of the aircraft during landing.

13. The vehicle as claimed in claim 10, wherein the inertial load is generated, at least in part, by an interaction between the aircraft and ground.

14. The vehicle as claimed in claim 13, wherein the vehicle support structure is arranged to sustain the inertial load when the aircraft is stationary and located on the ground.

15. The vehicle as claimed in claim 10, wherein the aircraft is a helicopter.

16. (canceled)

17. (canceled)

18. (canceled)

19. A land-based vehicle, comprising:
a roll cage comprising a rocket motor that is arranged to sustain an inertial load generated, at least in part, by the vehicle.

20. The land-based vehicle as claimed in claim 19, wherein the load is generated by motion of the vehicle.

21. The land-based vehicle as claimed in claim 19, wherein the rocket motor is arranged to generate a groundwards force.

22. A land-based vehicle, comprising:
a vehicle support structure comprising a casing of a rocket motor that is arranged to sustain a load, generated during motion of the vehicle, while the rocket motor is inactive.

23. (canceled)

24. (canceled)

25. (canceled)

26. (canceled)

27. A pallet comprising:
at least one rocket motor having a casing;
wherein the casing has a length dimension, a width dimension and a depth dimension, the length dimension being greater than the width dimension and the depth dimension; and
wherein the rocket motor is configured to generate a force in a direction that is substantially perpendicular to the length dimension of the casing.
